(19) United States
(12) Patent Application Publication
(10) Pub. No.: US 2017/0303587 A1
(43) Pub. Date: Oct. 26, 2017

(54) OVEN ASSEMBLY WITH A SHAFT ELEMENT

(71) Applicant: Intrepid Brands LLC, Louisville, KY (US)

(72) Inventors: David M. Johnson, Owensboro, KY (US); Charles H. Melander, Owensboro, KY (US); Michael G. Terry, Prospect, KY (US); Curtis R. Berry, Louisville, KY (US)

(21) Appl. No.: 15/492,715

(22) Filed: Apr. 20, 2017

Related U.S. Application Data
(60) Provisional application No. 62/326,402, filed on Apr. 22, 2016.

(51) Int. Cl. A24F 47/00; H05B 1/02

(52) U.S. Cl. CPC A24F 47/008; H05B 1/0244; H05B 2203/021

(57) ABSTRACT

The disclosure relates to an oven assembly for use with a personal electronic vaporizer configured to receive the oven assembly and heat a medium therein. The oven assembly may include a cup for use in heating the medium. The cup may define a pocket therein with a shaft extending into the pocket from a base plate. The shaft defines a shaft channel extending from the exterior of the cup to the pocket. As air is drawn through the personal electronic vaporizer, the air travels around the exterior of the cup and into the shaft channel to enter the pocket. The medium disposed therein is heated and vaporized and carried along to the user in the stream of air after it leaves the pocket.

### TECHNICAL FIELD

The present disclosure is directed to personal electronic vaporizers, which may be used to generate vapor from a number of substances, such as by using interchangeable heating chambers or oven assemblies comprising unexposed heating elements.

### BACKGROUND

Smoking devices, such as cigarette holders and pipes, are well known in the art for providing flavored vapor from a smokable substance to a user for smoking pleasure. However, such devices provide no means of controlling the heating and combustion of tobacco and other products. As a result, the devices tend to produce by-products which may impart a bitter and/or burnt taste to the mouth of a user, including combustion byproducts.

In an effort to overcome these issues, there have been numerous attempts to provide a device for delivering an active ingredient to a consumer through vaporization rather than combustion. For instance, many of the personal electronic vaporizers that are currently on the market heat a substance without burning it in order to release a vapor that contains the active ingredient(s) to be delivered to the user. In some instances, the vapor is created by placing the substance in contact with a metallic heating coil inside of a chamber, which may also be made of metal. Airflow is directed past the heated substance and exposed coil, often through pathways constructed of metal, resulting in the desired delivery of the vapor to the user. However, contact with metal may impart the vapor with undesirable flavor.

In addition to eliminating issues with the taste of vapor, most personal electronic vaporizers do not provide means for customizing the vaping experience. For example, many personal electronic vaporizers utilize the same heating profiles regardless of type of substance to be vaporized, e.g. a solid, liquid or wax. As a result, the user may not have the option to heat the substance to an ideal temperature that will maximize vapor generation without combusting the substance. Moreover, many personal electronic vaporizers fail to provide the user with an integrated means of filtering the vapor, and/or adjusting the flow of vapor to the user in a desired amount. For these and other reasons, there remains a need for a personal electronic vaporizer that allows for the delivery of a good tasting vapor to a user, while providing the user with a customizable vaping experience. While a variety of personal electronic vaporizers have been made and used, it is believed that no one prior to the inventors has made or used an invention as described herein.

### BRIEF DESCRIPTION OF THE DRAWINGS

While the specification concludes with claims which particularly point out and distinctly claim the invention, it is believed the present invention will be better understood from the following description of certain examples taken in conjunction with the accompanying drawing, in which like reference numerals identify the same elements and in which:

FIG. 1 is a perspective view of an exemplary personal electronic vaporizer;

FIG. 2 is an exploded view thereof;

FIG. 3 is a cross-sectional view thereof taken along line 3-3 of FIG. 1;

FIG. 4 is a perspective view of an exemplary oven assembly, an exemplary oven mount assembly, and an exemplary battery compartment assembly;

FIG. 5 is a cross-sectional view of the oven assembly and oven mount assembly of FIG. 4;

FIG. 6 is an exploded view of the oven assembly of FIG. 4;

FIG. 7 is a perspective view of the oven assembly of FIG. 4;

FIG. 8 is a top plan view of the oven mount assembly of FIG. 4;

FIG. 9 is an exploded view of the oven mount assembly of FIG. 4;

FIG. 10 is a perspective view of the oven assembly of FIG. 4 connected with the oven mount assembly of FIG. 4;

FIG. 11 is a cross-sectional view taken along line 11-11 of FIG. 10;

FIG. 12 is a perspective view of the personal electronic vaporizer of FIG. 1 and a mobile communication device;

FIG. 13 is an enlarged view of a portion of FIG. 3;

FIG. 14 is a perspective view of an exemplary charging base of the present invention;

FIG. 15 is a perspective view of the lower surface of an exemplary battery compartment assembly;

FIG. 16 is a perspective view of an exemplary oven assembly with an exemplary shaft element;

FIG. 17 is a perspective view of an exemplary plenum cup of the oven assembly of FIG. 16;

FIG. 18 is a perspective view of an exemplary inner cup of the oven assembly of FIG. 16;

FIG. 19 is a bottom perspective view of the plenum cup of FIG. 17 and the inner cup of FIG. 18;

FIG. 20 is a bottom perspective view of the inner cup of FIG. 18;

FIG. 21 is a top perspective view of the inner cup of FIG. 18 showing a set of shafts extending from a base plate of the inner cup;

FIG. 22 is a top view of the inner cup of FIG. 21;

FIG. 23 is a cross-sectional view of the oven assembly of FIG. 16 showing the inner cup disposed in the plenum cup; and

FIG. 24 is a cross-sectional view of an exemplary oven assembly without a plenum cup.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DETAILED DESCRIPTION

The following description of certain examples of the invention should not be used to limit the scope of the present invention. Other examples, features, aspects, embodiments, and advantages of the invention will become apparent to those skilled in the art from the following description, which is by way of illustration, one of the best modes contemplated for carrying out the invention. As will be realized, the invention is capable of other different and obvious aspects, all without departing from the invention. Accordingly, the drawings and descriptions should be regarded as illustrative in nature and not restrictive.

It will be appreciated that any one or more of the teachings, expressions, versions, examples, etc. described herein may be combined with any one or more of the other teachings, expressions, versions, examples, etc. that are described herein. The following-described teachings, expressions, versions, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

The elements or features of the various embodiments are described in detail hereinafter. Any reference to a singular characteristic or limitation of the present disclosure shall include the corresponding plural characteristics or limitations, and vice versa, unless otherwise specified or clearly implied to the contrary by the context in which the reference is made.

The apparatuses and methods described herein may comprise, consist of, or consist essentially of the elements and features of the disclosure described herein, as well as any additional or optional components, or features described herein or otherwise useful in relation to the aforementioned apparatuses and methods.

The term “personal electronic vaporizer,” which is used interchangeably herein with “PEV,” means a hand held electronic device which vaporizes one or more substances for consumption including, but not limited to, via inhalation, by a consumer. Non-limiting examples of substances include solids, liquids, gels and waxes. The PEV may take any shape to allow for the internal components as described below to be integrated therein.

### I. Personal Electronic Vaporizer

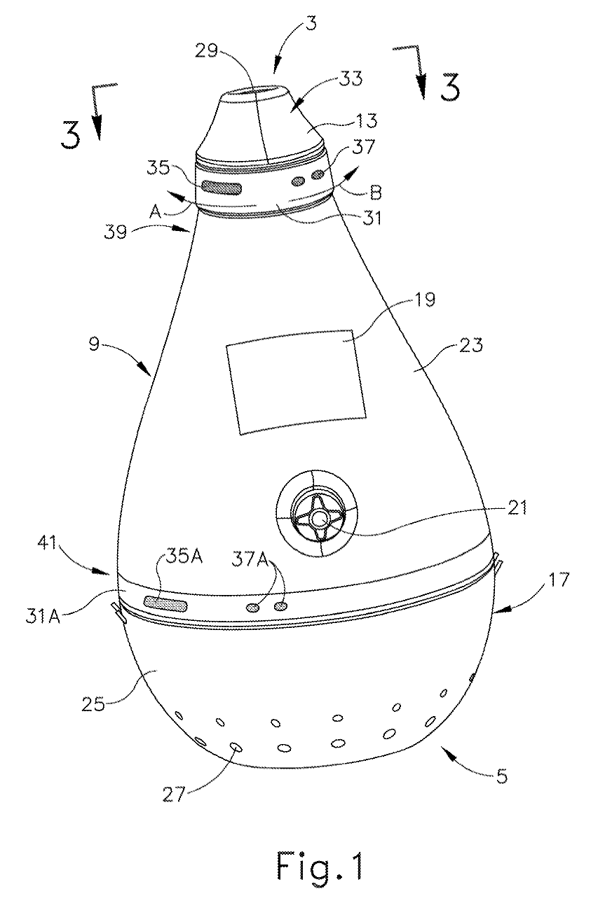

Referring now to FIGS. 1, 2, and 3, an embodiment of a personal electronic vaporizer is shown and described as PEV 1. PEV 1 extends generally from a top end 3 to a bottom end 5 and includes a mouthpiece assembly 7, a top shell assembly 9, a container assembly 11, one or more of an oven assembly 13, an oven mount assembly 15, and a battery compartment assembly 17. Each component or elements of a component may be formed or coated using a medical grade material, such as medical grade glass or medical grade stainless steel.

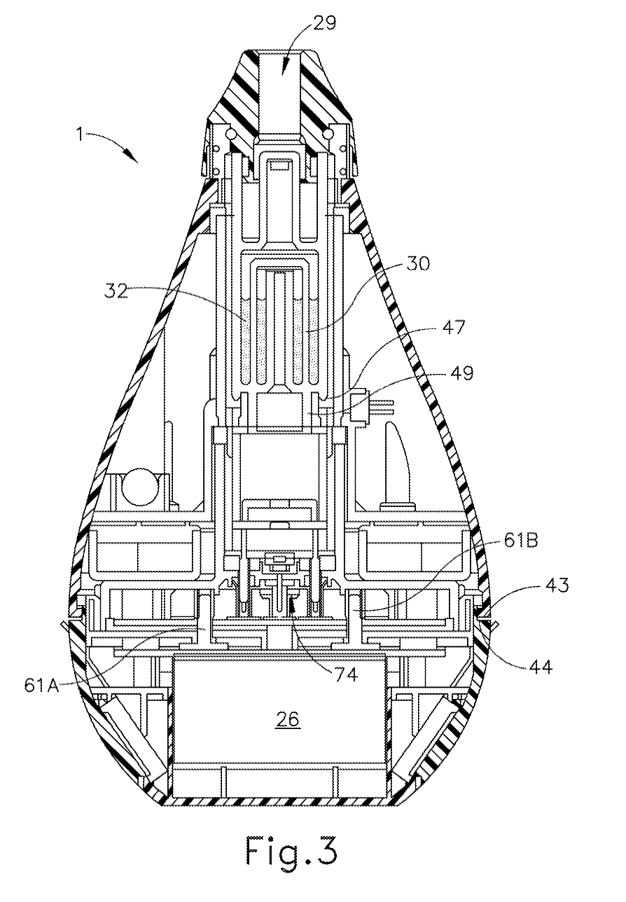

Mouthpiece assembly 7 defines a mouthpiece channel 29 surrounded by a material such as glass, ceramics, or polycarbonate. Mouthpiece assembly 7 includes a shaft 34 extending outwardly away from and continuing the channel 29 therethrough. Shaft 34 transitions into a shoulder 47 and a boss 49, with channel 29 extending therethrough. As shown in FIG. 3, channel 29 is a non-linear channel with multiple loop-backs and 180 degree turns as channel 29 extends from mouth area 33 to boss 49 and facilitate fluid communication between mouth area 33 and boss 49. As such, the turning and looping back of channel 29 creates a bubbler area 30 whereby a user may add water or other substances into channel 29 to fill bubbler area 30 and accordingly force any air or fluid passing through PEV 1 to pass through the substance in bubbler area 30. For example, a user may fill bubbler area 30 with an amount of tap water 32. As the user then draws fluid through PEV 1, the fluid passes through the tap water 32 in bubbler area 30 whereby heavier particles and water-soluble molecules are trapped in the tap water 32, thus preventing these particles from entering the user's airways. The user may turn the mouthpiece assembly 7 upside down to empty the tap water 32 from the bubbler area 30.

Top shell assembly 9 extends from a top end 39 to a bottom end 41 and includes a display screen 19 and a button 21. Display screen 19 is configured to be situated behind a mirrored or otherwise one way transparent outer surface 23 of top shell assembly 9, whereby the display screen 19 projects through the outer surface 23 when energized and illuminated, and does not project through the outer surface 23 when the display is not illuminated. Display screen 19 may be a liquid crystal display, a light emitting diode (LED) display, or any other mechanism for displaying visual information. Top shell assembly 9 further includes an annular lip 43 and a corresponding annular shoulder 44 proximate second end 41 for use in securing top shell assembly 9 to battery compartment assembly 17.

Top shell assembly 9 further includes a ring 31 proximate the top end 39. Ring 31 defines a primary intake opening 35 and a secondary intake opening 37 and is rotatable in the direction of Arrow A and Arrow B. Primary intake opening 35 may be rotated with respect to a corresponding underlying opening to adjust the size of the overall fluid pathway leading into the PEV 1. Similarly, secondary air intake opening 37 may be rotated with respect to a corresponding underlying opening to fine tune the size of the overall fluid pathway leading into the PEV 1. By rotating ring 31, the user can adjust the size of the openings for passing fluid into PEV 1 and ultimately affect the flow rate of fluid into the PEV 1. In another embodiment of PEV 1, ring 31 may be embodied by a ring 31A, disposed proximate the second end 41 of top shell assembly 9. Ring 31A operates similarly to ring 31, with a primary intake opening 35A and one or more secondary intake openings 37A. Ring 31A may be manually rotated by the user to open the intake openings in accordance with the preference of the user.

Container assembly 11 includes a hollow body 51 and a corresponding lid 53 for enclosing the hollow body 51. The container assembly 11 is shaped to define a recess 55 which generally corresponds to another portion of the PEV 1 such that the recess 55 mates with the other portion to be snuggly disposed thereon.

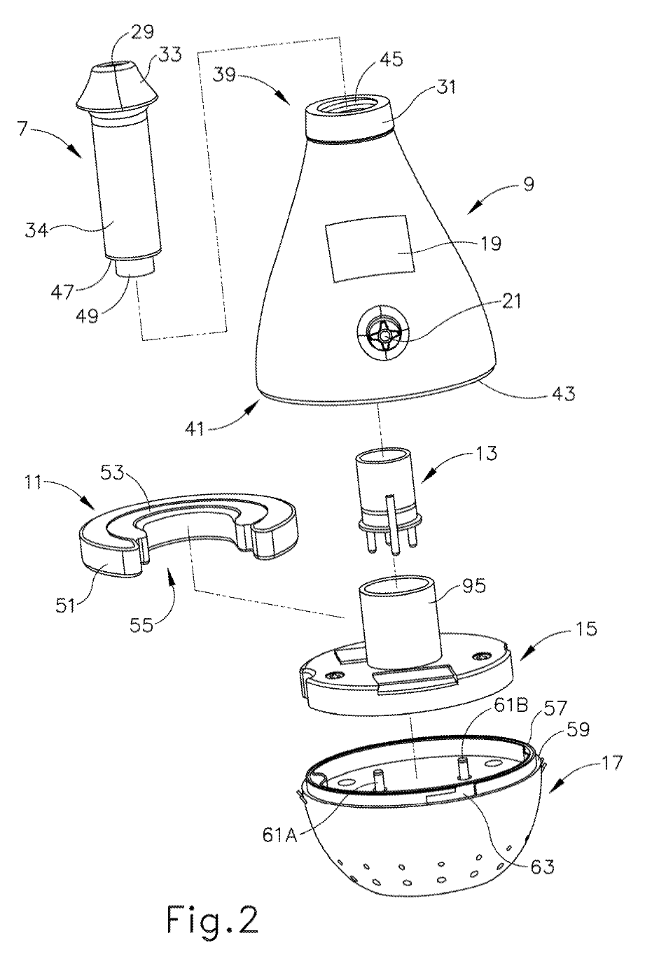

Battery compartment assembly 17 includes a battery 26 disposed proximate an outer wall 25. Outer wall 25 defines a series of dimples 27 for aesthetic purposes. Alternatively outer wall 25 may define vent holes (not shown), configured to expel excess heat generated through use of the battery 26 or may utilize vent holes to allow air to enter the PEV 1 and aid in the vaporization. Battery compartment assembly 17 further includes an annular lip 57 and a corresponding annular shoulder 59 sized and oriented to mate with annular lip 43 and annular shoulder 44 of top shell assembly 9 to selectively fittingly engage top shell assembly 9 with battery compartment assembly 17. Battery compartment assembly 17 further includes a pair of electrodes 61 configured to electronically couple with the positive and negative poles of the battery 26. The pair of electrodes 61 are shown in FIGS. 2 and 3 as electrode 61A and electrode 61B. The battery compartment assembly 17 may also include a latch 63 sized and oriented to mate with a corresponding latch (not shown) proximate the second end 41 of the top shell assembly 9 and slidingly engaged therewith to selectively hold top shell assembly 9 to battery compartment assembly 17.

Battery 26 is preferably a rechargeable battery, such as those that are currently used in electronic vaporizers (e.g., nickel cadmium batteries, lithium ion batteries, lithium ion polymer batteries, etc.). The battery may be recharged via an electrical wall outlet, a car charger, and/or a USB on a suitable power source (e.g., a computerized device).

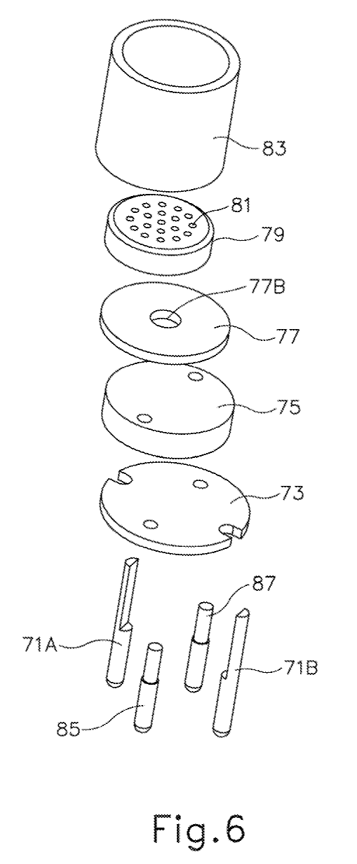

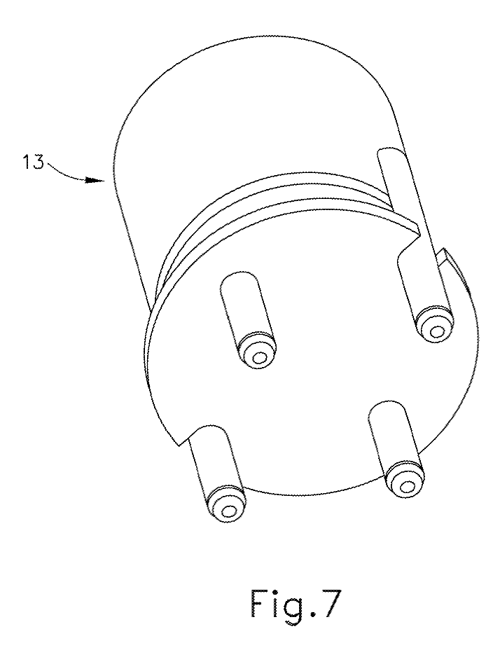

As shown in FIGS. 3-7, oven assembly 13 is sized to be removably received in a heater receptacle 95. As such, oven assembly 13 includes a generally cylindrical profile extending from a top end 67 to a bottom end 69. A pair of electrodes 71 extend outwardly at bottom end 69, with one electrode having a positive pole, shown as electrode 71A, and one electrode having a negative pole, shown as electrode 71B. Electrodes 71 transfer electric power from oven mount assembly 15 to a heating plate 73 configured to heat up and increase in temperature in accordance with the amount of electric power supplied from oven mount assembly 15. Heating plate 73 may include an integrated heating coil (not shown) disposed therein or a thermal film (not shown), a transparent film conductor (not shown), or any other mechanism for converting electrical power from battery 26 into heat.

A preheating area 74 (FIG. 3) may be disposed under and around heating plate 73. Preheating area is configured to be placed in the path of the air traveling through PEV 1 to the oven assembly 13, such as the air is preheated before traveling to oven assembly 13. The preheating area 74 increases the speed with which the PEV 1 may heat the air surrounding the medium in oven assembly 13, which in turn shortens the time the user has to wait to receive the vapors from the properly heated medium in oven assembly 13. The preheating area 74 may be configured to create a convection type of environment, whereby the air is circulated past heating elements to continuously warm and heat the air before the air is drawn into the oven assembly 13.

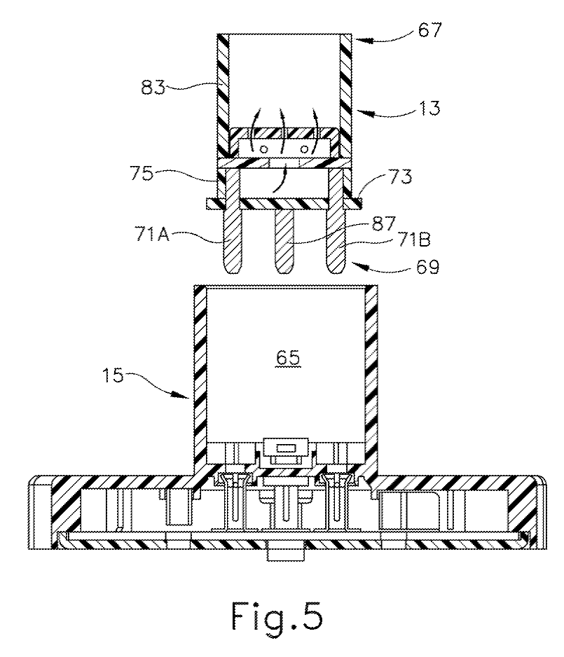

As shown in FIG. 5 oven assembly 13 further includes a porous ceramic tray 75 in an abutting relationship with heating plate 73 such that ceramic tray 75 absorb the heat generated by heating plate 73 and changes temperature generally in accordance with heating plate 73. Oven assembly 13 further includes a plenum ring 77 proximate ceramic tray 75 and defining an aperture 78 therethrough. Oven assembly 13 further includes an oven base 79 having a plurality of air holes 81 defined thereby for allowing the air to travel through in the direction of Arrows D. Oven base 79 is topped by a cylindrical shroud 83. As shown in FIG. 5, plenum ring 77 is configured to allow fluid to pass in through aperture 78 in the direction of Arrow C and thereafter pass through air holes 81 of oven base 79 in the direction of Arrows D. Oven assembly 13 may further include a porous glass filter or frit element (not shown) oriented such that the air may travel through the frit relatively slowly, reducing the flow rate of the air as the air travels through a pathway of PEV 1, to allow more time for the air to heat up and retain heat. The frit in turn acts to increase a dwell time for heat transfer along the pathway.

In an embodiment of the invention, the frit or glass filter may be disposed within ceramic tray 75, within aperture 78 and/or air holes 81, or layered between or adjacent to any of the various elements within oven assembly 13. For example, a frit layer may be disposed between plenum ring 77 and oven base 79 to slow the air passing through oven assembly 13 and allow a longer exposure to heating plate 73.

Oven assembly 13 may include zero, one, or two identification prongs. In the illustrated embodiment, oven assembly 13 includes a first identification prong 85 and a second identification prong 87. Identification prongs signal the intended heating profile of the particular oven assembly 13. As will be described in greater detail below, the identified heating profile is used by other components of PEV 1 to heat the oven assembly in accordance with specified criteria. In one embodiment of the present invention, the heating profile includes a goal temperature, wherein the PEV 1 heats the oven assembly 13 to the goal temperature specified by the heating profile. Inasmuch as both the first identification prong 85 and the second identification prong 87 may be present or absent in a particular oven assembly 13, the PEV 1 may use this presence or absence of these two components, or any combination thereof, as a signifier of a particular profile associated with the particular oven assembly 13. For example, the PEV 1 may be configured such that the presence of first identification prong 85 coupled with the absence of the second identification prong 87 indicates to the PEV 1 that a first heating profile is associated with the underlying oven assembly. If the first heating profile includes a goal temperature or goal temperature range of 345 to 355 degrees Fahrenheit, the PEV 1 will act to heat the medium in the oven assembly 13 to between 345 and 355 degrees. The temperature of the medium is determined through one or more sensors configured to sense or derive the temperature of the medium.

As discussed in greater detail below, PEV 1 may include temperature sensors. For example, infrared sensors, thermocouple style sensors, and/or thermistor style sensors for precise temperature sensing of the medium. One major deficiency of in the prior art relates to temperature control. PEV's in the prior art simply measure a mechanical element of the PEV, such as the heating coil or a particular plate or surface, and thereafter base the actuation or termination of the heating on those measured temperatures. However, the temperature of a particular PEV element and the temperature of the underlying medium may vary wildly. Thus, the PEV may actuate or terminate heating in an inefficient manner, with respect to the requirements of the medium for proper and efficient vapor generation. PEV 1 includes multiple sensors and logic circuitry configured to determine or derive the temperature of the medium itself and actuates or terminates the heating based on whether the temperature of the medium is within the goal range. This results in a greater experience for the user through the increased efficiency of heating and vaporizing the medium.

Different smokable substances or mediums may be best suited for different heating profiles. For example, a solid substance may be best suited for a first heating profile, while a liquid substance may be best suited for a second heating profile. Still further, a wax substance may require a third heating profile. As such, the user may select a particular oven assembly 13 based on intended substance and the heating profile associated with the selected oven assembly 13. For example, if a user wishes to vaporize solid tobacco in PEV 1, the user will select the oven assembly 13 configured for use with solid substances and load the selected oven assembly 13 into PEV 1. Thereafter, based on the arrangement of the first identification prong 85 and the second identification prong 87, the PEV 1 will recognize the particular heating profile associated with the selected oven assembly 13 and will heat the oven assembly 13 in the manner best suited for a solid sub stance.

Correlating the presence or absence of identification prongs is a non-limiting example of a mechanism for signaling different heating profiles in the present invention. Oven assemblies 13 may include alternative mechanisms for signaling a heating profile. For example, in certain configurations of PEV 1, a radio frequency identification (RFID) tags or other similar identification methods may be used or incorporated into the signaling of different heating profiles.

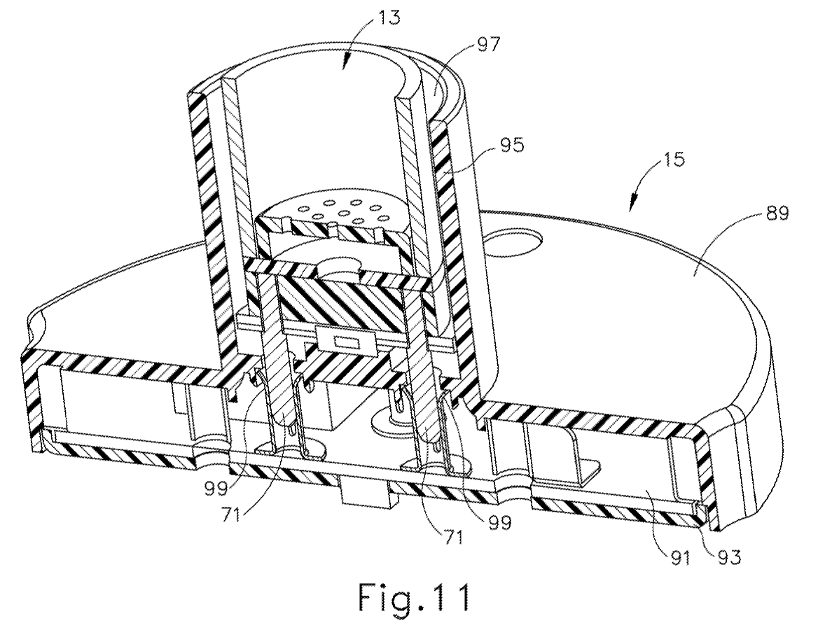

As shown in FIGS. 5, 8, and 9, oven mount assembly 15 includes three main components: a cap 89, a circuit board assembly 91, and a backing plate 93. Cap 89 defines multiple recesses and apertures for accessing elements on circuit board assembly 91 through cap 89. Cap 89 includes a heater receptacle 95 that defines a channel 97 therein for receiving a selected oven assembly 13. Cap 89 includes a pair of electrode through holes 99 configured to allow a corresponding electrode 71 of an oven assembly 13 to pass through cap 89 and into elements of the circuit board assembly 91 (FIG. 11). Similarly, cap 89 includes a pair of identification prong through holes 101 configured to allow first identification prong 85 and second identification prong 87 to pass through cap 89 and into elements of the circuit board assembly 91. As such, cap 89 is primarily configured to receive a selected oven assembly 13 into heater receptacle 95 and align the electrodes 61 and identification prongs 85 and 87 with underlying elements of circuit board assembly 91.

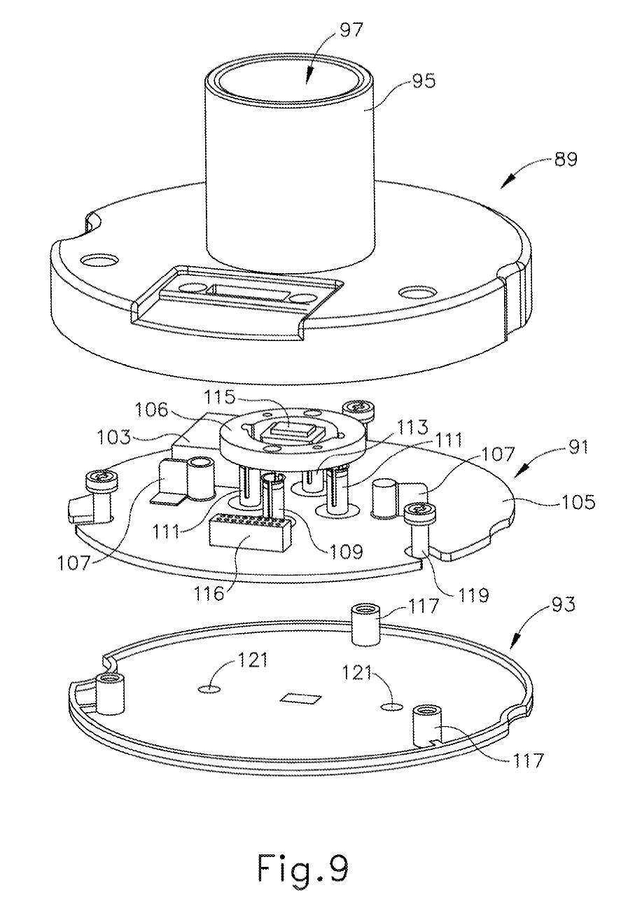

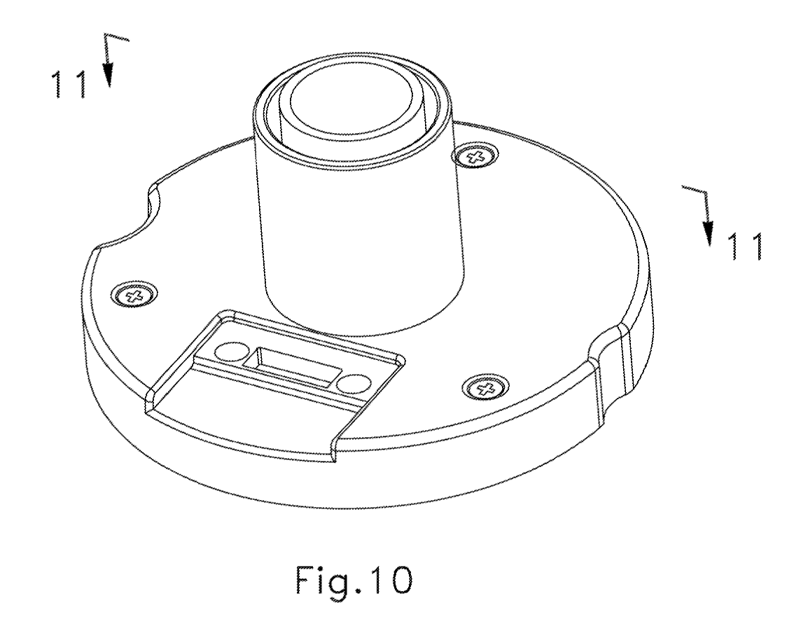

As shown in FIG. 9, circuit board assembly 91 includes various electronic components, logic, and support structure to enable battery 26 to interface with oven assembly 13 as desired. As such, circuit board assembly 91 includes a microprocessor 103 coupled with a circuit board 105. A pair of receiving terminals 107 are disposed on the circuit board 105 proximate a bracket 106, configured to receive electrodes 61 extending from the battery 26 and electronically couple the battery 26 to the circuit board 105 to energize the circuit board assembly 91. Similarly, a pair of receiving terminals 109 are disposed on the circuit board 105, configured to receive electrodes 71 extending from oven assembly 13 and electronically couple the oven assembly 13 with the circuit board assembly 91. Circuit board assembly 91 further includes an identification terminal 111 and an identification terminal 113, whereby identification terminal 111 is configured to receive first identification prong 85 therein and identification terminal 113 is configured to receive second identification prong 87 therein. As such, circuit board assembly 91 may poll identification terminal 111 and identification terminal 113 to determine whether the particular selected oven assembly 13 includes one or both of the first identification prong 85 and the second identification prong 87, or whether the selected oven assembly 13 does not include either prong. As discussed above, the circuit board assembly 91 can derive the particular heating profile for the selected oven assembly 13 based on the presence or absence of one or both of the first identification prong 85 and the second identification prong 87.

Circuit board assembly 91 further includes a temperature sensor 115 extending from circuit board 105 and oriented to be proximate the oven assembly 13 when an oven assembly 13 is disposed in heater receptacle 95. Temperature sensor 115 is illustrative of one embodiment of the present invention, as circuit board assembly 91 may further include multiple infrared sensors (not shown), thermocouple style sensors (not shown), and thermistors style sensors (not shown) for precise sensing or derivation of the temperature of the medium for use in control of the heat directed at the smoking substance or medium. Circuit board assembly 91 further includes a jumper socket 116 configured to receive corresponding electrical wiring (not shown) from display screen 19 and button 21 and electronically and logically couple display screen 19, button 21, and microprocessor 103 such that microprocessor 103 may actuate display screen 19 in accordance with the logic stored therein and in accordance with actuation of the button 21 by the user. While circuit board assembly 91 is shown as a feature of oven mount assembly 15, in other embodiments of the present invention, circuit board assembly 91 or a similar element thereof, may be disposed in other assemblies or components of PEV 1. For example, in an embodiment of the invention, a circuit board assembly may be disposed in the top shell assembly 9. Alternatively, PEV 1 may include a master controller and slave controller disposed anywhere in the PEV 1 and in communication through various wiring and logic circuitry.

Backing plate 93 is sized and configured to brace circuit board assembly 91 and hold circuit board assembly 91 firmly between cap 89 and backing plate 93. As such, backing plate 93 includes a plurality of fastener receivers 117 for receiving a corresponding series of fasteners 119 therein, whereby fasteners 119 are configured to pin and hold the circuit board assembly 91 to backing plate 93. Backing plate 93 defines a pair of apertures 121 aligned and sized to allow electrodes 61 from battery 26 to pass through backing plate 93 and into receiving terminals 107 of circuit board assembly 91.

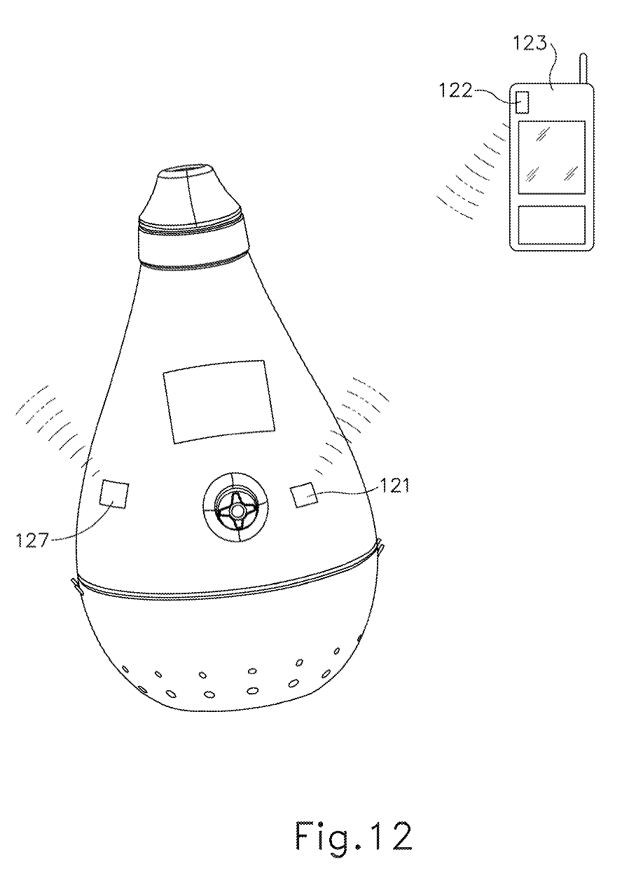

As shown in FIG. 12, PEV 1 may include a wireless module 121 electronically coupled with microprocessor 103 through corresponding wiring (not shown). Wireless module 121 is configured to wirelessly electronically couple with a corresponding wireless communication module 122 of a mobile communication device 123. The mobile communication device 122 includes logic and circuitry to connect wireless communication module 122 with an interface application 125 having a graphical user interface (not shown). The interface application 125 may be configured to respond to input from the user and transmit these user commands from mobile communication device 122 to PEV 1. In turn, PEV 1 is configured to receive these user commands via the wireless module 121 and provide these commands to microprocessor 103. Microprocessor 103 interprets these user commands and actuates the various components and elements of PEV 1 accordingly. Microprocessor 103 is further configured to collect various metrics, data points, and related information and provide this data to mobile communication device 123 for display to the user through interface application 125.

PEV 1 may further include a speaker 127 electronically coupled with microprocessor 103 through corresponding wiring (not shown). Speaker 127 is configured to receive information and data from microprocessor 103 and transmit sound waves in accordance with the received information. For example, microprocessor 103 may provide musical data to speaker 127, whereby speaker 127 transmits this musical data as sound waves to the user through PEV 1. Speaker 127 may ultimately be controlled by a user through any combination of display screen 19, button 21, and interface application 125 on mobile communication device 123.

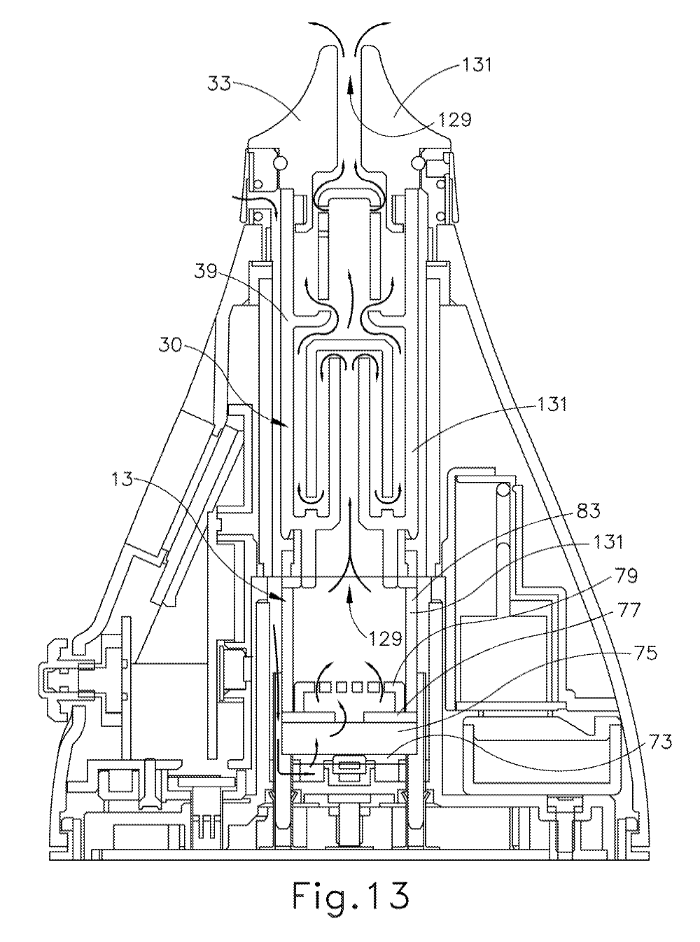

PEV 1 may further include a pathway 129 surrounded entirely by a material 131 and extending from inside the oven assembly 13 out through the mouthpiece channel 29 of the mouthpiece assembly 7. As shown in FIG. 13 and starting inside the oven assembly 13, tray 75, ring 77, oven base 79, and cylindrical shroud 83 are all formed of the material 131. Further, shaft 34 defining bubbler area 30 and mouth area 33 are also formed of the material 131. As such, as the medium is heated in oven assembly 13, the medium itself and the vapors emitted therefrom is entirely surrounded by the material 131 as the vapors travel along pathway 129. In an embodiment of the invention, the material is inert, chemically stable, and thermodynamically stable. This ensures the vapors are untainted by the material as the vapors travel along pathway 129. Further, by heating oven assembly 13 through heating plate 73, situated outside of pathway 129, the vapors are untainted by electrical components of PEV 1, such as heating coils or other undesirable elements that may alter the vapors or the medium in undesirable ways. In an embodiment of the invention, the material 131 is a relatively pure glass material, a ceramic glass material, a relatively pure ceramic material, or a polycarbonate material. The term “relatively pure” signifies the material may include some common slight impurities or colorants.

In operation, a user my grasp PEV 1 and rotate top shell assembly 9 and battery compartment assembly 17 axially to disengage latch 63 and release the two components. This release exposes container assembly 11 to the user, which may be detached from around heater receptacle 95 of oven mount assembly 15. The user thereafter opens lid 53 of compartment assembly 17 to expose the medium stored in hollow body 51. Depending on the medium, the user thereafter selects the appropriate oven assembly 13. For example, if the medium is a solid, the user may select a corresponding oven assembly 13 configured to properly and efficiently heat a solid medium using a particular heating profile associated with the selected oven assembly 13. Alternatively, if the medium is a liquid or a wax, another more appropriate oven assembly 13 may be selected.

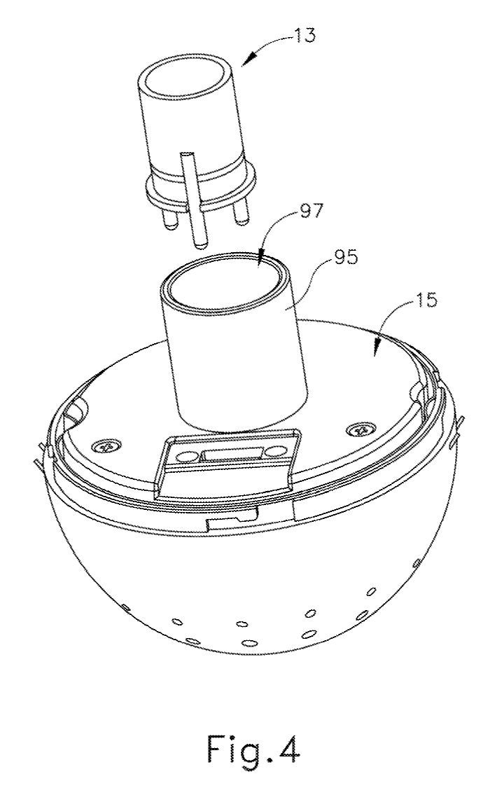

After the oven assembly 13 is selected, the user inserts the medium into the cylindrical shroud such that the medium rests on oven base 79. As illustrated in FIG. 4, the user thereafter inserts the selected oven assembly 13 into channel 97 of heater receptacle 95 of oven mount assembly 15 in the direction of Arrow D. The oven assembly 13 is inserted into heater receptacle 95 in a particular orientation, whereby each electrode 71A and 71B is passed through electrode through holes 99 of cap 89 and is received in corresponding receiving terminals 109 of circuit board assembly 91. Similarly, if the selected oven assembly 13 includes a first identification prong 85, the first identification prong 85 is passed through one of the identification prong through holes 101 and is received in corresponding receiving terminal 111 of circuit board assembly 91. If the selected oven assembly 13 includes second identification prong 87, the second identification prong 87 is passed through one of the identification prong through holes 101 and is received in corresponding receiving terminal 113 of circuit board assembly 91.

Once the selected oven assembly 13 is loaded with the medium and inserted into the oven mount assembly 15, the user then aligns top shell assembly 9 with battery compartment assembly 17 and axially twists the two elements to engage latch 63 to firmly hold top shell assembly 9 to battery compartment assembly 17. If desired, the user may then remove the mouthpiece assembly 7 and fill bubbler area 30 with liquid, such as water, for filtering the vapors of the medium.

Once the mouthpiece assembly 7 is coupled with the top shell assembly 9 and the selected oven assembly 13 is disposed in the oven mount assembly 15, the PEV 1 is actuated to heat the medium in the oven assembly 13. The heating may be actuated by the user through manual manipulation of button 21 or through manipulation of interface application 125 on mobile communication device 123 and feedback may be provided to the user through display screen 19.

In response to a heating request by the user, the microprocessor 103 polls identification terminal 111 and identification terminal 113 to determine the particular configuration, through a combination of the presence or absence of the first identification prong 85 and the second identification prong 87, of the selected oven assembly 13. In one example, the presence or absence of the identification prongs correlates to a two digit binary number such as 00, 01, 10, or 11 stored in a lookup table in the microprocessor 103. The microprocessor 103 thereafter retrieves the particular heating profile associated with the configuration of the identification prongs and initiates heating of the heating plate 73 in accordance with the retrieved heating profile. The heating of heating plate 73 is performed by energizing heating plate 73 through a current supplied by battery 26 and tailored to the heating profile.

Next, the medium is heated in the oven assembly 13 through heating of the heating plate 73. The user thereafter orally engages mouth area 33 of mouthpiece assembly 7 and applies negative pressure on the mouthpiece assembly 7 to draw air through PEV 1. The negative pressure at mouthpiece assembly 7 draws air from primary intake opening 35 and secondary intake openings 37 through oven assembly 13 and around the heated medium. The vapors from the heated medium are drawn up through pathway 129, through bubbler area 30, and into mouthpiece channel 29, where the vapors are inhaled or otherwise utilized by the user. The user may selectively rotate ring 31 on top shell assembly 9 to expose or cover primary intake opening 35 and/or secondary intake openings 37 and customize the pressure and air flow through the PEV 1. The vapors from the heated medium travel along pathway 129, which is entirely surrounded by material 131 configured to not taint or chemically disrupt the vapors.

The entire experience may be enhanced by actuating PEV 1 to play music or other audible sounds through speaker 127.

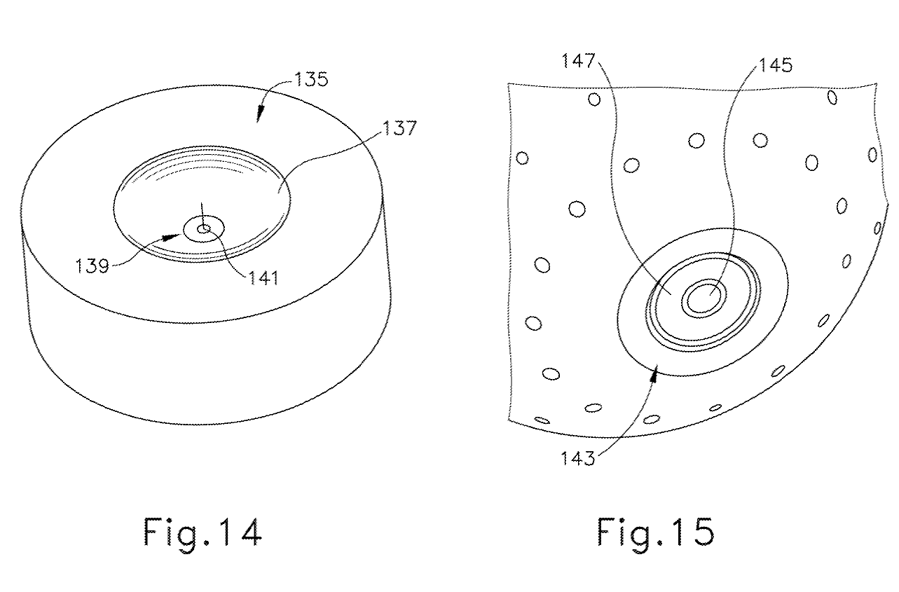

As shown in FIGS. 14 and 15, a charging base 135 may be provided to recharge battery 26. Charging base 135 includes a power cord (not shown) configured to draw power from a wall outlet or other similar power source. Charging base 135 further includes a recess 137, wherein a positive charging pole 139 and a negative charging pole 141 reside. As shown on FIG. 15, the bottom surface of battery compartment assembly 17 may include a charging area 143 complementarily shaped to mate with recess 137. Charging area 143 includes a positive charging pole 147 configured to mate with positive charging pole 139 and a negative charging pole 145 configured to mate with negative charging pole 141. The mating of the poles completes a charging circuit between battery 26 and charging base 135 and acts to recharge battery 26. Charging base 135 may be configured to provide over five amps of charging to the battery 26. In one embodiment of the charging base 135, the battery 26 is charged using a twenty amp circuit to allow for quick charging of battery 26, which may be less than ten minutes. While charging base 135 is shown and described herein, any other mechanism for recharging battery 26 is contemplated, such as a USB style power cord or a standard power cord plugged directly into the body of battery compartment assembly 17.

### II. Oven Assembly with a Shaft Element

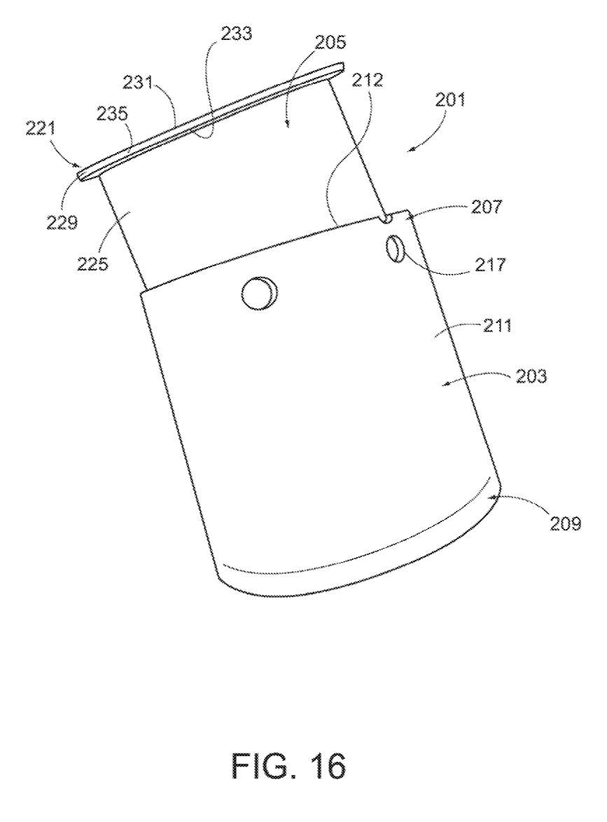

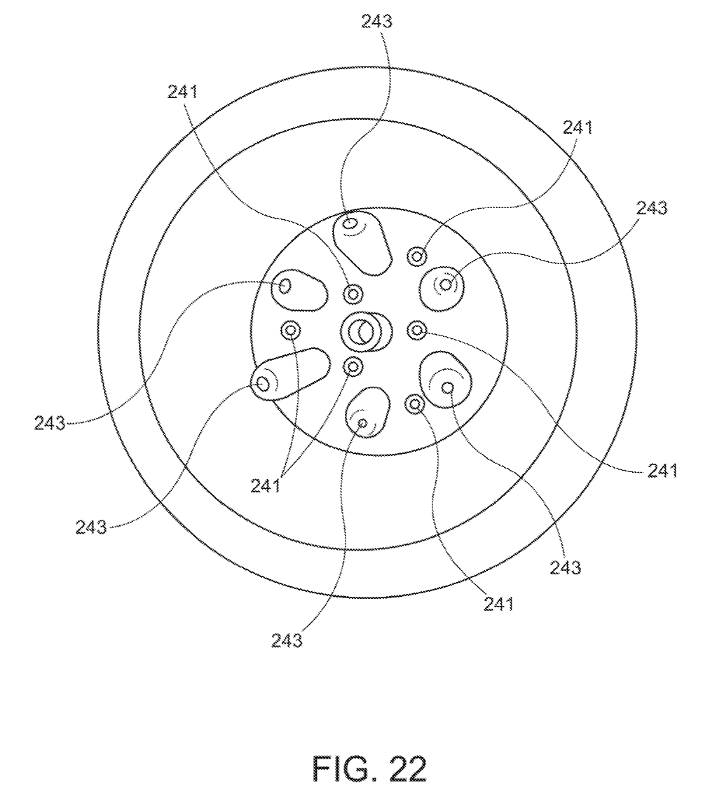

As shown in FIGS. 16-24, other embodiments of an oven assembly with a shaft element and suitable for incorporation with personal electronic vaporizer 1 may comprise a one part oven assembly. Other versions may comprise a two-part oven assembly. Still other versions may comprise a two-part oven with the two parts fused together to form a one-part oven assembly.

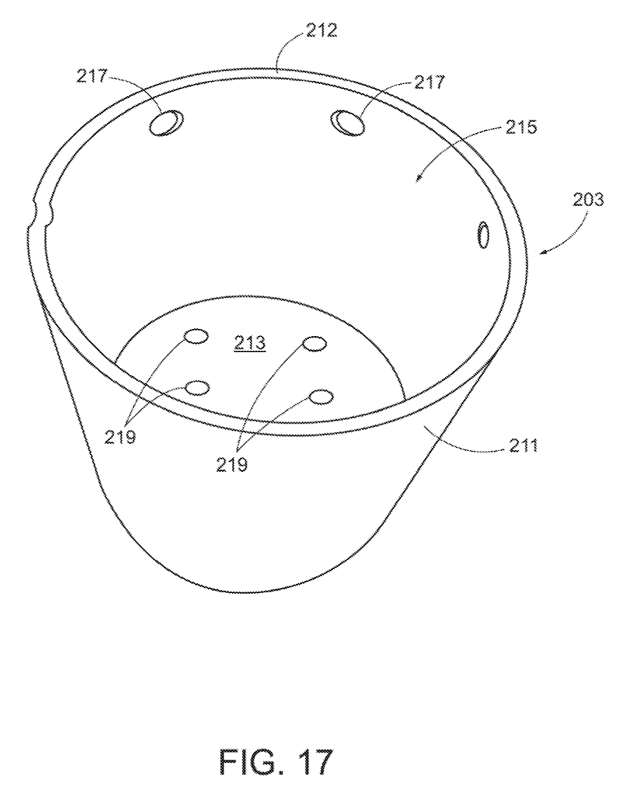

As shown in FIGS. 16-18, an oven assembly 201 includes a plenum cup 203 sized to receive all or a portion of an inner cup 205 therein. Plenum cup 203 extends from a first end 207 to a spaced apart second end 209 and includes an arcuate exterior wall 211 terminating in a base plate 213. Exterior wall 211 includes an upper peripheral surface 212 proximate first end 207. Exterior wall 211 and base plate 213 cooperate to define a pocket 215 (FIG. 17) having a generally circular cross-sectional area, referred to hereinafter as the plenum cup cross-sectional area. Pocket 215 is open at first end 207 and extends from first end 207 to second end 209. Exterior wall 211 defines a set of plenum channels 217 proximate first end 207 of plenum cup 203. Base plate 213 defines a set of post holes 219 therein. Plenum channels 217 may be omitted in some versions of oven assembly 201.

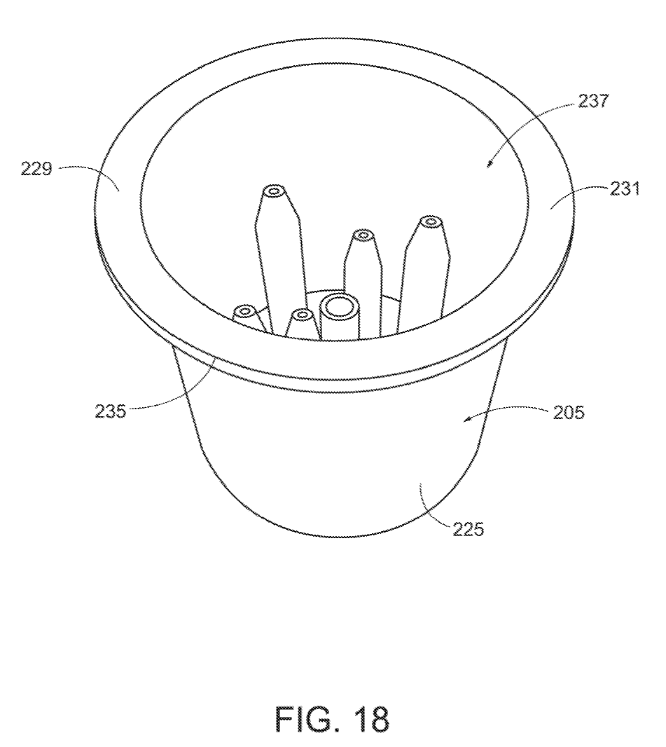

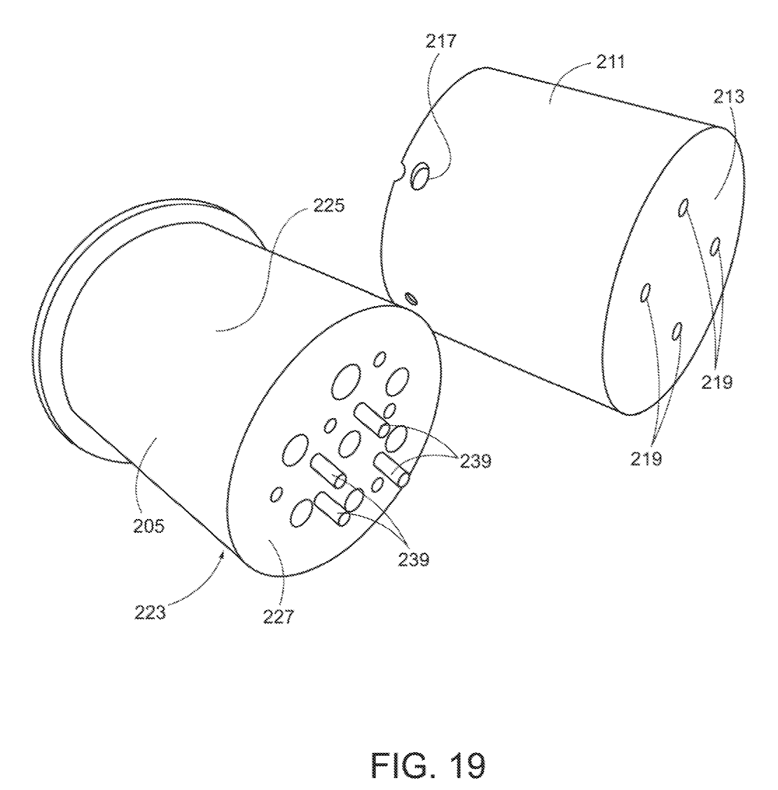

As shown in FIGS. 16-19, inner cup 205 extends from a first end 221 to a spaced apart second end 223 (FIG. 19) and includes and arcuate exterior wall 225 terminating in a base plate 227. A lip 229 extends around the periphery of the upper portion of exterior wall 225 proximate first end 211 of inner cup 205. Lip 229 includes a top surface 231, a bottom surface 233 and an outer side surface 235. Exterior wall 225 and base plate 227 cooperate to define a pocket 237 (FIG. 18) having a generally circular cross-sectional area, referred to hereinafter as the inner cup cross-sectional area.

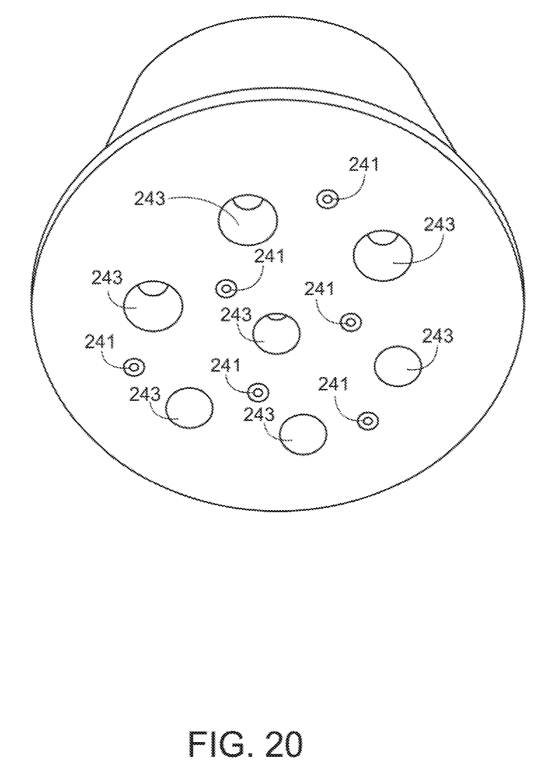

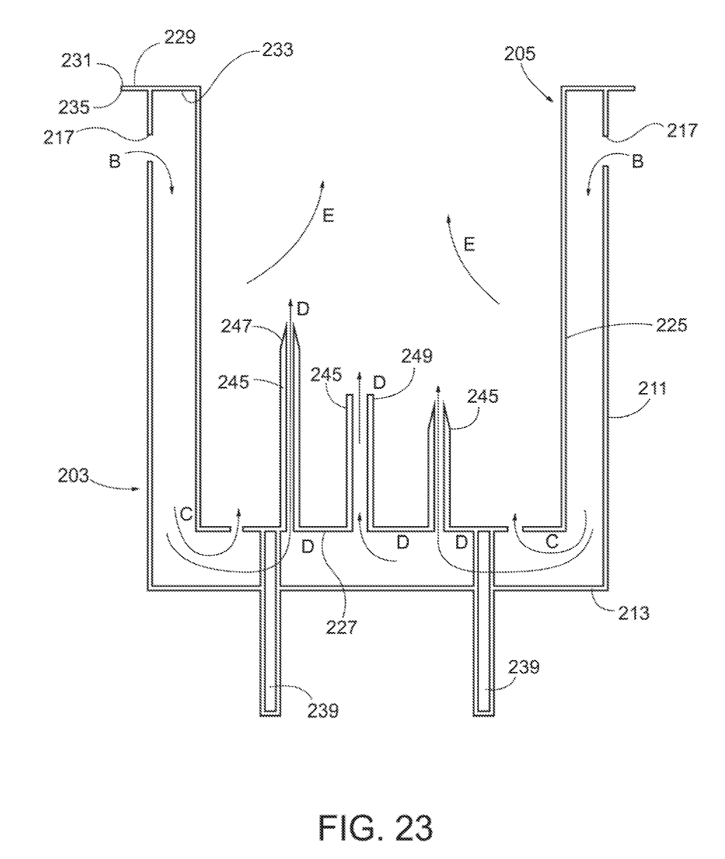

The inner cup cross-sectional area is generally less than the plenum cup cross-sectional area to allow for a portion of the inner cup 205 to removably extend into the pocket 215 of the plenum cup 203 (FIG. 23). Lip 229 prevents inner cup 205 from extending entirely into pocket 215 of plenum cup 203 by abutting the bottom surface 233 of lip 229 with the upper peripheral surface 212 of plenum cup 203. Lip 229 further provides a grasping area for the user to manually manipulate inner cup 205 and selectively engage inner cup 205 with plenum cup 203 or disengage inner cup 205 from plenum cup 203 by manually pulling inner cup 205 by lip 229 out of pocket 215 of plenum cup 203. The set of post holes 219 defined by base plate 213 of plenum cup 203 are sized for receiving a corresponding set of posts 205 therethrough and extending outwardly away from base plate 227 and second end 223 of inner cup 205. FIG. 20 omits posts 205 only for the purpose of better illustrating other features of inner cup 205.

As shown in FIGS. 20-23, base plate 227 of inner cup 205 defines a set of base channels 241 extending from the exterior of inner cup 205 to pocket 237 through base plate 227. Base channels 241 facilitate fluid communication between the exterior area of second end 223 and pocket 237 of inner cup 205. Inner cup 205 further defines a set of shaft channels 243 extending from the exterior of inner cup 205 through base plate 227 and through a set of corresponding shafts 245 disposed in pocket 237 of inner cup 205. On the interior of inner cup 205, each shaft 245 extends from base plate 227 into pocket 237, generally from second end 223 of inner cup 205 towards first end 221. Each shaft 245 surrounds and defines the corresponding shaft channel 243 to facilitate fluid communication between the exterior area of second end 223 and pocket 237 of inner cup 205.

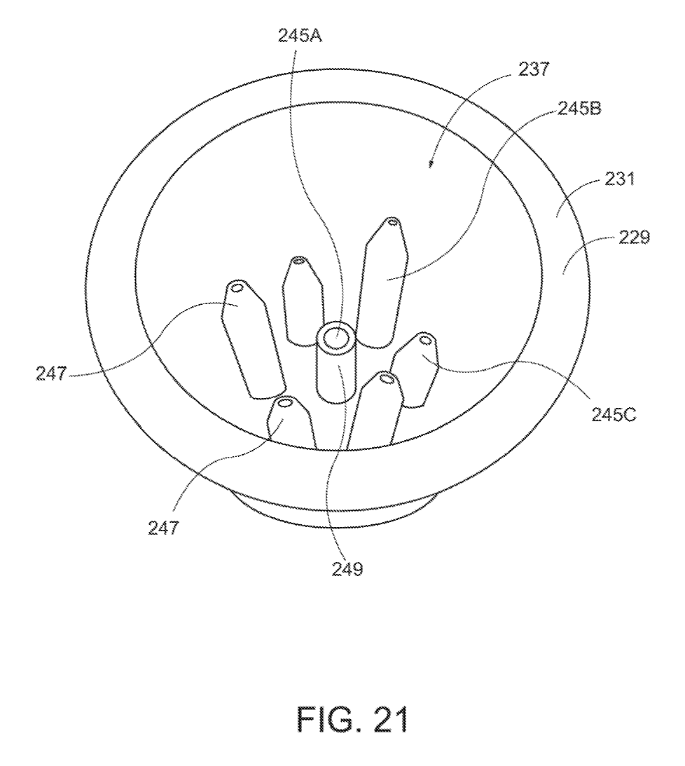

As shown in FIG. 21, shafts 245 may be positioned and sized accordingly to allow for even heating throughout pocket 237. A shaft 245, indicated as shaft 245A, may be placed in the direct center of base plate 227, whereby shaft 245A include a first length and may define a shaft channel 243A having a first diameter. Shaft 245A may also or alternatively supply hot air or heat to pocket 237. Shaft 245A may be configured to hold and position a temperature sensor (not shown) configured to measure the temperature of the item being vaporized. Another shaft 245, indicated as shaft 245B may be placed between shaft 245A and exterior wall 225 and may include a second length and may define a shaft channel 243B having a second diameter. Yet another shaft 245, indicated as shaft 245C, may be offset from shaft 245A and shaft 245B and may include a third length and may define a shaft channel 243C having a third diameter. Any given shaft 245 may also include a tapered head 247 or a straight head 249. Shafts 245 provide an even distribution of the heated air into and around the material being vaporized. The positioning of spikes 245 is to facilitate a maximum rate of heat transfer by minimizing the heat transfer distance. The heat transfer distances are optimized to obtain rapid, efficient, and uniform heat transfer to the material being vaporized.

As shown in FIG. 23, inner cup 205 is sized to be slidably received in pocket 215 of plenum cup 203. The various features of plenum cup 203 and inner cup 205 are complementarily sized to define a plenum space 251 between base plate 227 of inner cup 205 and base plate 213 of plenum cup 203 when inner cup 205 is received in pocket 215 of plenum cup 203. Lip 229 is sized and configured to prevent inner cup 205 from sliding entirely into pocket 215 of plenum cup 203 by abutting upper peripheral surface 212 of exterior wall 211. Plenum space 251 facilitates fluid communication between the exterior of plenum cup 203 and the interior of inner cup 205 by way of an airflow pathway. In some versions of oven assembly 201, airflow pathway extends from the exterior of plenum cup 203, through plenum channels 217, between plenum cup 203 and inner cup 205, through plenum space 251, into shaft channels 243, and into pocket 237. In other versions of oven assembly 201, the airflow pathway may omit the plenum channels 217.

Various electrical heating features (not shown) are provided in one or more of base plate 213 of plenum cup 203, exterior wall 211 of plenum cup 203, base plate 227 of inner cup 205, and exterior wall 225 of inner cup 213. These electrical heating features may be in the form of a heating coil or any other mechanism for heating portions of oven assembly 201. Electrical heating features draw electrical power through posts 239, which are configured to electronically couple with a battery such as battery 26 (FIG. 3) to provide power to oven assembly 201. Alternatively, electrical heating features may be positioned to draw power to the base of the plenum or any other location that allows for heating of the oven assembly or the air without having the air contact any metallic heating surfaces. In other embodiments of the present invention, plenum cup 203 or any plenum style features may be omitted and the medium to be vaporized may be directly heated and/or vaporized by heating spikes 245 or other elements within heating assembly 201.

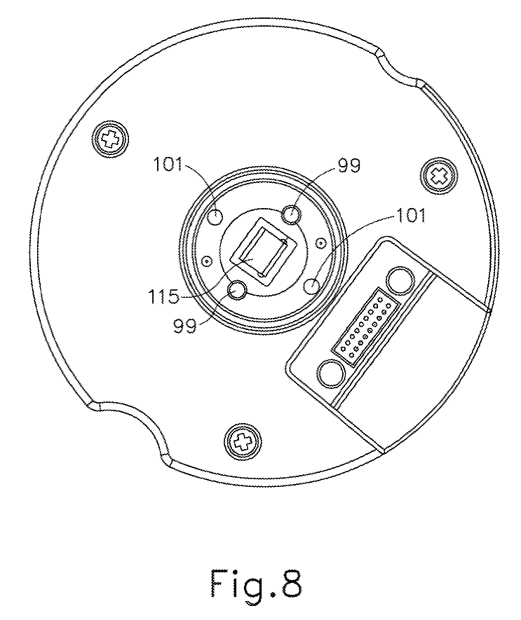

Oven assembly 201 may also include one or more sensors such as temperature sensor 115 (FIG. 8) for sensing the temperature of any of the elements of oven assembly 201 and providing the temperature measurements to a decision making element of the vaporizer such as micro microprocessor 103 (FIG. 9) for use in adjusting the temperature of the electrical heating features and maintaining an even heat throughout oven assembly 201. Sensors may be in the form of infrared sensors or any other temperature sensing elements and may also draw power through a battery via posts 239.

Oven assembly 201 is configured for use with a vaporizer such as vaporizer 1, shown in FIG. 1. As shown in FIG. 23, when a user draws fluid (e.g. air) through the vaporizer, the fluid passes from the exterior of plenum cup 203 through plenum channels 217, as shown by Arrow A. The air plenum facilitated by plenum cup 211 and exterior wall 225 of inner cup 205 may be sealed to insure the proper direction of airflow. The fluid travels along the path created between exterior wall 211 of plenum cup 205 and exterior wall 225 of inner cup 205 and is heated by the various electrical heating features disposed at desired locations in oven assembly 201. As the fluid approaches base plate 213 of plenum cup 203, plenum space 251 aids in equalizing pressure between the exterior of the vaporizer and pocket 237 of inner cup 205 and to allow for an even heating of the material disposed in pocket 237. The fluid travels in the direction of Arrows B, Arrows C, and Arrows D, through plenum space 251, and into pocket 237. With respect to Arrows B and C, a portion of the fluid travels through base channels 241 and into pocket 237. With respect to Arrows D, a portion of the fluid travels through shaft channels 243 and into pocket 237. Ultimately, all of the drawn fluid travels in the direction of Arrows E, outwardly away from pocket 237 and into other portions of the vaporizer to be provided to the user. A substance within pocket 237 is heated and vaporized accordingly through a combination of the radiant heat from the electrical heating elements and the heated fluid passing through plenum cup 203 and into inner cup 205.

The various features of plenum cup 203 and inner cup 205 are configured to cooperate to provide even heating of the substance within pocket 237, whereby the substance is heated at the same rate at the same time whether the substance is located near exterior wall 225 of inner cup 205, located near the center of base plate 227, or located an upward distance from base plate 227 within pocket 237. For example, as shown in FIG. 18, each shaft 245 may be configured according to its individual length, width, thickness, taper of head, and inner shaft channel 243 diameter, to provide for even heating of a substance within pocket 237. A method for configuring the various elements of oven assembly 201 may be derived using differential calculus and by incorporating the actual or desired rate of temperature change within pocket 237 or any other various elements within oven assembly 201.

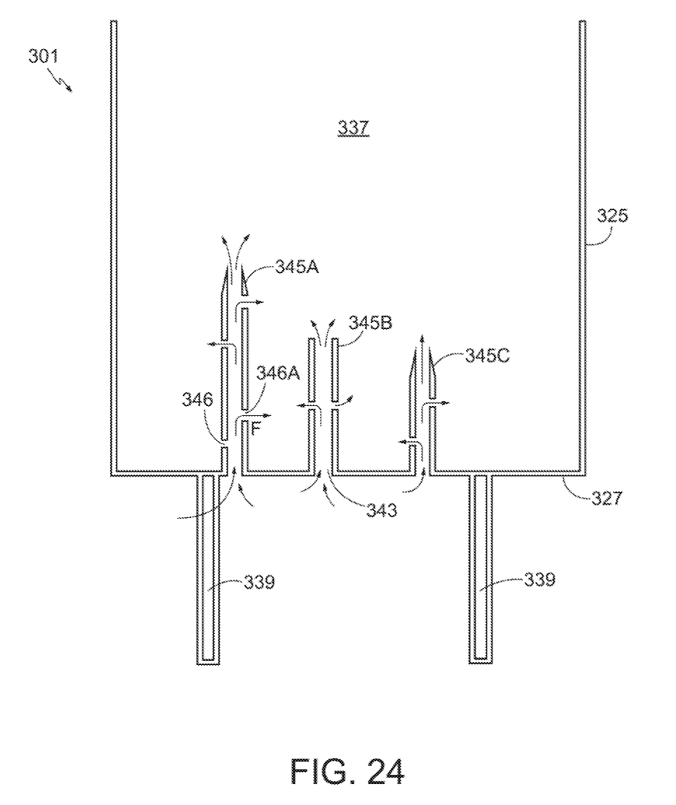

Another version of an oven assembly of the present invention is shown in FIG. 24 as oven assembly 301. Oven assembly 301 omits a plenum cup and provides oven functionality through a single element configured to sit on top of a plenum structure provided by PEV 1. Alternatively, oven assembly 301 may be comprised of a plenum structure fused with an inner cup structure.

Oven assembly 301 is similar to inner cup 205 in many respects and includes an exterior wall 325 and a base plate 327 oriented to define a pocket 337 therebetween. Oven assembly 301 further includes a set of posts 339, whereby electrical heating features of oven assembly 301 are configured to draw electrical power through posts 339. Posts 339 are configured to electronically couple with a battery such as battery 26 (FIG. 3) to provide power to heating assembly 301. Oven assembly further includes a plurality of shafts 345, with each shaft 345 defining a corresponding shaft channel 343 therethrough. Shaft channels 343 are the only opening between pocket 337 and the lower side of base plate 327 as oven assembly 301 does not include base channels 241 in a base plate 327. Oven assembly 301 further includes additional, generally horizontal, vent holes 346 branching off from shaft channels 343.

As shown in FIG. 24, heated air travels through base plate 327 and into shaft channels 343 in the direction of the various arrows. The heated air then travels upwardly inside each shaft 345 and outwardly from the particular shaft 345 through either vent holes 346 or the uppermost distal opening of shaft channel 343. Arrow F illustrates heated air exiting vent hole 346A of shaft 345A to provide even heating around pocket 337. Shafts 245B and 245C may define vent holes 346 having different orientations or relative positions along the length of shaft 245B and shaft 245C.

### III. Exemplary Combinations

The following examples relate to various non-exhaustive ways in which the teachings herein may be combined or applied. It should be understood that the following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. It is also contemplated that some variations may omit certain features referred to in the below examples. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.

### Example 1

An oven assembly configured for use with a personal electronic vaporizer, the oven assembly comprising a first cup; and a second cup, wherein the second cup is sized to receive the first cup therein.

### Example 2

The oven assembly of any of the previous or subsequent Examples, wherein the first cup comprises a first exterior wall extending from a first end to a second end; a first base plate disposed at the second end of the first exterior wall; and a first pocket defined by the first exterior wall and the first base plate.

### Example 3

The oven assembly of any of the previous or subsequent Examples, wherein the first cup comprises a lip disposed at the first end of the first exterior wall.

### Example 4

The oven assembly of any of the previous or subsequent Examples, wherein the first cup comprises at least one post extending from the first base plate.

### Example 5

The oven assembly of any of the previous or subsequent Examples, wherein the first base plate is configured to heat the pocket in response to receiving power through the at least one post.

### Example 6

The oven assembly of any of the previous or subsequent Examples, wherein the first cup comprises a first shaft having a first length and extending from the first base plate into the first pocket; and a first shaft channel defined by the first shaft and the first base plate, wherein the first shaft channel extends from the first pocket to the exterior of the first cup.

### Example 7

The oven assembly of any of the previous or subsequent Examples, wherein the first shaft includes a tapered head.

### Example 8

The oven assembly of any of the previous or subsequent Examples, wherein the first cup comprises a second shaft having a second length extending from the first base plate into the first pocket; and a second shaft channel defined by the second shaft and the first base plate, wherein the second shaft channel extends from the first pocket to the exterior of the first cup, wherein the first length and the second length are different.

### Example 9

The oven assembly of any of the previous or subsequent Examples, wherein the first shaft and the second shaft include a tapered head.

### Example 10

The oven assembly of any of the previous or subsequent Examples, wherein the second cup comprises a second exterior wall extending from a first end to a second end; a second base plate disposed at the second end of the second exterior wall; and a second pocket defined by the second exterior wall and the second base plate.

### Example 11

The oven assembly of any of the previous or subsequent Examples, wherein the second base plate defines at least one post hole therein, wherein the post hole is sized to allow a post of the first cup to pass therethrough.

### Example 12

The oven assembly of any of the previous or subsequent Examples, wherein the second exterior wall defines a channel therein.

### Example 13

A method of forming an oven assembly for use within a personal electronic vaporizer, the method comprising disposing a first cup in a second cup to form an oven assembly.

### Example 14

The method of any of the previous or subsequent Examples, further comprising defining an interior and an exterior of the first cup; defining an interior and an exterior of the second cup; and forming an airflow pathway from the exterior of the second cup to the interior of the first cup while the first cup is disposed in the second cup.

### Example 15

The method of any of the previous or subsequent Examples, further comprising disposing a first shaft having a first length in the interior of the first cup; and forming a channel in the first shaft, wherein the airflow pathway includes the channel of the first cup.

### Example 16

The method of any of the previous or subsequent Examples, further comprising disposing a second shaft having a second length in the interior of the first cup; forming a channel in the second shaft, wherein the airflow pathway includes the channel of the second cup, wherein the first length and the second length are different.

### Example 17

The method of any of the previous or subsequent Examples, further comprising tapering a distal end of the first shaft.

### Example 18

The method of any of the previous or subsequent Examples, further comprising heating a base plate of the first cup while the first cup is disposed in the second cup.

### Example 19

The method of any of the previous or subsequent Examples, further comprising extending a post from the base plate of the first cup through a base plate of the second cup; and connecting a power source to the base plate of the first cup via the post.

### Example 20

An oven assembly configured for use with a personal electronic vaporizer, the oven assembly comprising a base plate; a wall extending from the base plate, wherein the wall and base plate define an exterior of the oven assembly; a pocket, wherein the pocket is defined by the wall and base plate; a shaft rising from the base plate into the pocket; and a shaft channel defined by the shaft, wherein the shaft channel extends between the exterior of the oven assembly and the pocket.

### IV. Miscellaneous

It should be understood that any of the examples described herein may include various other features in addition to or in lieu of those described above. By way of example only, any of the examples described herein may also include one or more of the various features disclosed in any of the various references that are incorporated by reference herein.

It should be understood that any one or more of the teachings, expressions, embodiments, examples, etc. described herein may be combined with any one or more of the other teachings, expressions, embodiments, examples, etc. that are described herein. The above-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

Having shown and described various versions of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, versions, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

I/We claim:

1. An oven assembly configured for use with a personal electronic vaporizer, the oven assembly comprising:
(a) a first cup; and
(b) a second cup, wherein the second cup is sized to receive the first cup therein.

2. The oven assembly of claim 1, wherein the first cup comprises:
(a) a first exterior wall extending from a first end to a second end;
(b) a first base plate disposed at the second end of the first exterior wall; and
(c) a first pocket defined by the first exterior wall and the first base plate.

3. The oven assembly of claim 2, wherein the first cup comprises a lip disposed at the first end of the first exterior wall.

4. The oven assembly of claim 2, wherein the first cup comprises at least one post extending from the first base plate.

5. The oven assembly of claim 4, wherein the first base plate is configured to heat the pocket in response to receiving power through the at least one post.

6. The oven assembly of claim 2, wherein the first cup comprises:
(a) a first shaft having a first length and extending from the first base plate into the first pocket; and
(b) a first shaft channel defined by the first shaft and the first base plate, wherein the first shaft channel extends from the first pocket to the exterior of the first cup.

7. The oven assembly of claim 6, wherein the first shaft includes a tapered head.

8. The oven assembly of claim 6, wherein the first cup comprises:
(a) a second shaft having a second length extending from the first base plate into the first pocket; and
(b) a second shaft channel defined by the second shaft and the first base plate, wherein the second shaft channel extends from the first pocket to the exterior of the first cup, wherein the first length and the second length are different.

9. The oven assembly of claim 8, wherein the first shaft and the second shaft include a tapered head.

10. The oven assembly of claim 1, wherein the second cup comprises:
(a) a second exterior wall extending from a first end to a second end;
(b) a second base plate disposed at the second end of the second exterior wall; and
(c) a second pocket defined by the second exterior wall and the second base plate.

11. The oven assembly of claim 10, wherein the second base plate defines at least one post hole therein, wherein the post hole is sized to allow a post of the first cup to pass therethrough.

12. The oven assembly of claim 10, wherein the second exterior wall defines a channel therein.

13. A method of forming an oven assembly for use within a personal electronic vaporizer, the method comprising disposing a first cup in a second cup to form an oven assembly.

14. The method of claim 13, further comprising:
(a) defining an interior and an exterior of the first cup;
(b) defining an interior and an exterior of the second cup; and
(c) forming an airflow pathway from the exterior of the second cup to the interior of the first cup while the first cup is disposed in the second cup.

15. The method of claim 14, further comprising:
(a) disposing a first shaft having a first length in the interior of the first cup; and
(b) forming a channel in the first shaft, wherein the airflow pathway includes the channel of the first cup.

16. The method of claim 15, further comprising:
(a) disposing a second shaft having a second length in the interior of the first cup;
(b) forming a channel in the second shaft, wherein the airflow pathway includes the channel of the second cup, wherein the first length and the second length are different.

17. The method of claim 15, further comprising tapering a distal end of the first shaft.

18. The method of claim 13, further comprising heating a base plate of the first cup while the first cup is disposed in the second cup.

19. The method of claim 18, further comprising:
(a) extending a post from the base plate of the first cup through a base plate of the second cup; and
(b) connecting a power source to the base plate of the first cup via the post.

20. An oven assembly configured for use with a personal electronic vaporizer, the oven assembly comprising:
(a) a base plate;
(b) a wall extending from the base plate, wherein the wall and base plate define an exterior of the oven assembly;
(c) a pocket, wherein the pocket is defined by the wall and base plate;
(d) a shaft extending from the base plate into the pocket; and
(e) a shaft channel defined by the shaft, wherein the shaft channel extends between the exterior of the oven assembly and the pocket.
